(19) United States
(12) Patent Application Publication
(10) Pub. No.: US 2025/0239955 A1
(43) Pub. Date: Jul. 24, 2025

(54) MOTOR CONTROL METHOD

(71) Applicants: HYUNDAI MOTOR COMPANY, Seoul (KR); KIA CORPORATION, Seoul (KR)

(72) Inventor: Min Ho Chae, Incheon (KR)

(73) Assignees: HYUNDAI MOTOR COMPANY, Seoul (KR); KIA CORPORATION, Seoul (KR)

(21) Appl. No.: 18/802,693

(22) Filed: Aug. 13, 2024

(30) Foreign Application Priority Data
Jan. 18, 2024 (KR) 10-2024-0007784

(51) Int. Cl. H02P 25/22

(52) U.S. Cl. CPC H02P 25/22

(57) ABSTRACT

A control method includes equally controlling a phase angle of a first part motor including first type three-phase coils and a phase angle of a second part motor including second type three-phase coils in a rotational speed region equal to or lower than a reference rotational speed. The control method also includes differently controlling the phase angle of the first part motor and the phase angle of the second part motor in a rotational speed region higher than the reference rotational speed.

### CROSS REFERENCE TO RELATED APPLICATION

This application claims priority to Korean Patent Application No. 10-2024-0007784, filed on Jan. 18, 2024, the entire contents of which are incorporated herein for all purposes by this reference.

### FIELD

The present disclosure relates to a technology related to a method of controlling a six-phase motor capable of being used to operate a vehicle.

### BACKGROUND

A hybrid or electric vehicle generates driving power, which is required to drive the vehicle, by operating a motor by using electric power provided from a battery mounted in the vehicle.

The motor for a vehicle requires high efficiency in order to satisfy electric power efficiency and output performance of the vehicle.

The foregoing explained as the background of the disclosure is intended merely to help the understanding of the background of the present disclosure and is not intended to mean that the present disclosure falls within the purview of the related art that is already known to those having ordinary skill in the art.

### SUMMARY

The present disclosure is proposed to solve these problems and aims to provide a motor control method capable of more effectively providing power performance required for a vehicle. The motor control method may more effectively control a six-phase motor in which the number of series turns per phase of one three-phase coil is different from the number of series turns per phase of the remaining three-phase coil.

In order to achieve the above-mentioned object, the present disclosure provides a motor control method for controlling a six-phase motor. The method includes controlling a maximum current applied to a first part motor to be equal to a maximum current applied to a second part motor. The first part motor includes first type three-phase coils, and the second part motor includes second type three-phase coils having a smaller number of series turns per phase than the first type three-phase coils. The method also includes equally controlling output torque of the first part motor including the first type three-phase coils and output torque of the second part motor including the second type three-phase coils in a region, in which required torque of the six-phase motor is equal to or lower than predetermined reference torque. The method also includes differently controlling the output torque of the first part motor and the output torque of the second part motor in a region, in which the required torque of the six-phase motor is higher than the reference torque.

The method may also include setting the reference torque to twice maximum torque of the second part motor.

The method may also include, in the region, in which the required torque of the six-phase motor is higher than the reference torque, differently controlling the output torque of the first part motor and the output torque of the second part motor in accordance with a ratio between a torque constant of the first part motor and a torque constant of the second part motor.

The method may also include equally controlling a phase angle of the first part motor and a phase angle of the second part motor in a rotational speed region equal to or lower than a predetermined reference rotational speed. The method may also include differently controlling the phase angle of the first part motor and the phase angle of the second part motor in a rotational speed region higher than the reference rotational speed.

The method may also include setting the reference rotational speed to a base rotational speed of the first part motor.

The method may also include setting an operation region, in which only the second part motor is operated, to a rotational speed region higher than an operation region, in which only the first part motor is operated.

The present disclosure also provides a device including a non-transitory computer-readable storage medium storing instructions executable to perform a motor control for a six-phase motor. The device also includes a processor configured to execute the instructions to control a maximum current applied to a first part motor of the six-phase motor to be equal to a maximum current applied to a second part motor of the six-phase motor. The first part motor includes first type three-phase coils, and the second part motor includes second type three-phase coils having a smaller number of series turns per phase than the first type three-phase coils. The processor is also configured to equally control an output torque of the first part motor including the first type three-phase coils and an output torque of the second part motor including the second type three-phase coils in a region in which a required torque of the six-phase motor is equal to or lower than a predetermined reference torque. The processor is also configured to differently control the output torque of the first part motor and the output torque of the second part motor in a region in which the required torque of the six-phase motor is higher than the predetermined reference torque.

The processor is also configured to execute the instructions to, in the region, in which the required torque of the six-phase motor is higher than the predetermined reference torque, differently control the output torque of the first part motor and the output torque of the second part motor based on a ratio between a torque constant of the first part motor and a torque constant of the second part motor.

The processor is also configured to execute the instructions to set the predetermined reference torque to twice maximum torque of the second part motor.

The processor is also configured to execute the instructions to equally control a phase angle of the first part motor and a phase angle of the second part motor in a rotational speed region equal to or lower than a predetermined reference rotational speed. The processor is also configured to execute the instructions to differently control the phase angle of the first part motor and the phase angle of the second part motor in a rotational speed region higher than the predetermined reference rotational speed.

The processor is also configured to execute the instructions to set the predetermined reference rotational speed to a base rotational speed of the first part motor. The processor is also configured to execute the instructions to set an operation region, in which only the second part motor is operated, to a rotational speed region higher than an operation region in which only the first part motor is operated. The processor is also configured to execute the instructions to set a number of turns of the first type three-phase coil to be larger by 10% or more than a number of turns of the second type three-phase coil.

In addition, in order to achieve the above-mentioned object, the present disclosure provides a motor control method for controlling a six-phase motor. The method includes controlling a maximum current applied to a first part motor to be equal to a maximum current applied to a second part motor. The first part motor includes first type three-phase coils, and the second part motor includes second type three-phase coils having a smaller number of series turns per phase than the first type three-phase coils. The method also includes equally controlling a phase angle of the first part motor and a phase angle of the second part motor in a rotational speed region equal to or lower than a predetermined reference rotational speed. The method also includes differently controlling the phase angle of the first part motor and the phase angle of the second part motor in a rotational speed region higher than the reference rotational speed.

The method may also include setting the reference rotational speed to a base rotational speed of the first part motor.

The method may also include setting an operation region, in which only the second part motor is operated, to a rotational speed region higher than an operation region, in which only the first part motor is operated.

The method may also include equally controlling output torque of the first part motor and output torque of the second part motor in a region, in which required torque of the six-phase motor is equal to or lower than twice maximum torque of the second part motor. The method may also include differently controlling the output torque of the first part motor and the output torque of the second part motor in accordance with a ratio between a torque constant of the first part motor and a torque constant of the second part motor in a region higher than twice the maximum torque of the second part motor.

In addition, in order to achieve the above-mentioned object, the present disclosure provides a motor control method for controlling a six-phase motor. The method includes controlling a maximum current applied to a first part motor to be equal to a maximum current applied to a second part motor. The first part motor includes first type three-phase coils, and the second part motor includes second type three-phase coils having a smaller number of series turns per phase than the first type three-phase coils. The method also includes dividing a six-phase operation region, in which the six-phase motor operates in six phases, into four operation regions in accordance with a predetermined reference rotational speed and reference torque. The method also includes equally controlling a phase angle of the first part motor and a phase angle of the second part motor and equally controlling torque of the first part motor and torque of the second part motor in a first six-phase operation region, in which a rotational speed is equal to or lower than the reference rotational speed, and torque region is equal to or lower than the reference torque among the four operation regions. The method also includes differently controlling the phase angle of the first part motor and the phase angle of the second part motor and equally controlling the torque of the first part motor and the torque of the second part motor in a second six-phase operation region, in which a rotational speed is higher than the reference rotational speed, and torque is equal to or lower than the reference torque among the four operation regions. The method also includes equally controlling the phase angle of the first part motor and the phase angle of the second part motor and differently controlling the torque of the first part motor and the torque of the second part motor in a third six-phase operation region, in which a rotational speed is equal to or lower than the reference rotational speed, and torque is higher than the reference torque among the four operation regions. The method also includes differently controlling the phase angle of the first part motor and the phase angle of the second part motor and differently controlling the torque of the first part motor and the torque of the second part motor in a fourth six-phase operation region, in which a rotational speed is higher than the reference rotational speed, and torque is higher than the reference torque among the four operation regions.

The method may also include setting the reference rotational speed, based on which the four operation regions are separated, to a base rotational speed of the first part motor. The method may also include setting the reference torque to twice maximum torque of the second part motor.

The method may also include setting a second three-phase operation region, in which only the second part motor is operated, to a rotational speed region higher than a first three-phase operation region, in which only the first part motor is operated.

The method may also include setting the first three-phase operation region and the second three-phase operation region may be set to overlap in the first six-phase operation region and the second six-phase operation region.

The method may also include, in case that the torque of the first part motor and the torque of the second part motor are differently controlled, differently controlling the output torque of the first part motor and the output torque of the second part motor in accordance with the ratio between the torque constant of the first part motor and the torque constant of the second part motor.

According to the present disclosure, it is possible to more effectively provide power performance required for a vehicle by more effectively controlling a six-phase motor in which the number of series turns per phase of one three-phase coil is different from the number of series turns per phase of the remaining three-phase coil.

### BRIEF DESCRIPTION OF THE DRAWINGS

FIG. 1 is a view illustrating a structure of a dual winding six-phase motor to which the present disclosure may be applied.

FIG. 2 is a view conceptually illustrating six-phase coils disposed in a stator in FIG. 1.

FIG. 3 is a view illustrating a drive circuit for operating the six-phase motor in FIG. 1.

FIG. 4 is a graph illustrating a maximum output line of a first part motor, a maximum output line of a second part motor, and a maximum combined output line that indicates a sum of the maximum output line of the first part motor and the maximum output line of the second part motor of the dual winding six-phase motor to which the present disclosure is applied.

FIG. 5 is a graph illustrating operation regions of the six-phase motor according to the present disclosure on the graph in FIG. 4.

### DETAILED DESCRIPTION

Hereinafter, embodiments disclosed in the present disclosure are described in detail with reference to the accompanying drawings. The same or similar constituent elements are assigned with the same reference numerals regardless of reference numerals, and the repetitive description thereof has been omitted.

The suffixes “module”, “unit”, “part”, and “portion” used to describe constituent elements in the following description are used together or interchangeably in order to facilitate the description, but the suffixes themselves do not have distinguishable meanings or functions. When a controller, module, component, device, element, unit, part, portion, or the like of the present disclosure is described as having a purpose or performing an operation, function, or the like, the controller, module, component, device, element, unit, part, portion, or the like should be considered herein as being “configured to” meet that purpose or to perform that operation or function. Each controller, module, component, device, element, unit, part, portion, and the like may separately embody or be included with a processor and a memory, such as a non-transitory computer readable media, as part of the apparatus.

In the description of the embodiments disclosed in the present disclosure, the specific descriptions of publicly known related technologies have been omitted when it is determined that the specific descriptions may obscure the subject matter of the embodiments disclosed in the present disclosure. In addition, it should be interpreted that the accompanying drawings are provided only to allow those having ordinary skill in the art to easily understand the embodiments disclosed in the present disclosure. The technical spirit disclosed in the present disclosure is not limited by the accompanying drawings and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present disclosure, it should be understood the terms “comprises,” “comprising,” “includes,” “including,” “containing,” “has,” “having” or other variations thereof are inclusive and therefore specify the presence of stated features, integers, steps, operations, elements, components, or combinations thereof. The terms do not preclude the presence or addition of one or more other features, integers, steps, operations, elements, components, or combinations thereof.

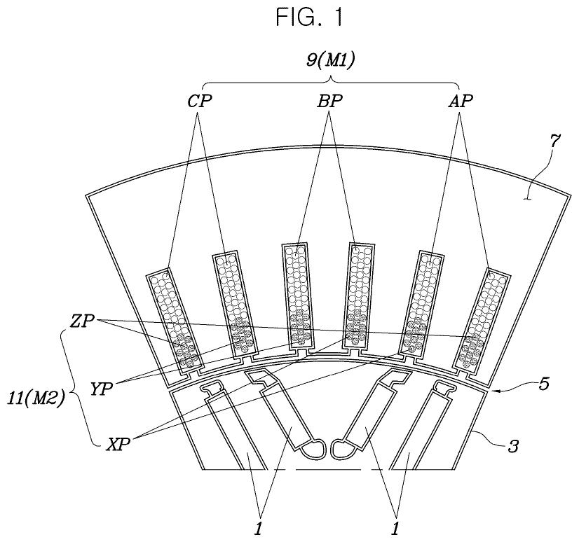

With reference to FIGS. 1, 2, and 3, a structure of a dual winding six-phase motor to which a motor control method of the present disclosure is applied is described.

With reference to FIG. 1, a rotor 3 having permanent magnets 1 is disposed at a center of the six-phase motor. A stator 7 is provided to surround the rotor 3 and defines an air gap 5 together with the rotor 3. The stator 7 has first type three-phase coils 9 and second type three-phase coils 11.

For reference, FIG. 1 is a view illustrating a partial sector of the six-phase motor. The illustrated components substantially define a complete circle to constitute a single six-phase motor based on the rotor 3.

In this case, the second type three-phase coil 11 has the number of series turns per phase smaller than the number of series turns per phase of the first type three-phase coil 9.

In other words, for example, in case that the first type three-phase coils 9 include an A-phase coil AP, a B-phase coil BP, and a C-phase coil CP and the second type three-phase coils 11 include an X-phase coil XP, a Y-phase coil YP, and a Z-phase coil ZP, the A-phase coil AP, the B-phase coil BP, and the C-phase coil CP, which are the first type three-phase coils 9, are wound with eight turns, respectively, and the X-phase coil XP, the Y-phase coil YP, and the Z-phase coil ZP, which are the second type three-phase coils 11, are wound with four turns, respectively.

In particular, the number of turns of the first type three-phase coil 9 is larger by at least 10% or more than the number of turns of the second type three-phase coil 11, such that the number of series turns per phase of the first type three-phase coil 9 is also larger than by 10% or more than the number of series turns per phase of the second type three-phase coil 11.

The A-phase coil AP, the B-phase coil BP, and the C-phase coil CP are sequentially disposed in a circumferential direction of the stator 7. The X-phase coil XP, the Y-phase coil YP, and the Z-phase coil ZP are sequentially disposed in the direction in which the A-phase coil AP, the B-phase coil BP, and the C-phase coil CP are disposed.

The first type three-phase coils 9, which are disposed at equal interval in the circumferential direction based on a rotation axis of the six-phase motor, may constitute a first part motor M1 together with the rotor 3. The second type three-phase coils 11, which are disposed at equal intervals in the circumferential direction based on the rotation axis of the six-phase motor, may constitute a second part motor M2 together with the rotor 3.

In other words, the six-phase motor of the present disclosure may comprise the first part motor M1 and the second part motor M2. The current may be applied only to the first type three-phase coils 9, which constitute the first part motor M1, such that the first part motor M1 may be substantially operated as the three-phase motor. The current may be applied only to the second type three-phase coils 11, which constitute the second part motor M2, such that the second part motor M2 may also be operated as the three-phase motor.

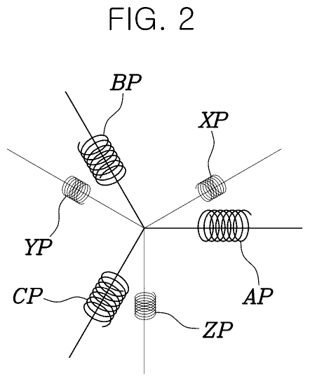

As illustrated in FIG. 2, the A-phase coil AP, the B-phase coil BP, the C-phase coil CP, the X-phase coil XP, the Y-phase coil YP, and the Z-phase coil ZP may be disposed so that an A phase, an X phase, a B phase, a Y phase, a C phase, and a Z phase are formed sequentially and repeatedly in the circumferential direction of the stator 7.

Meanwhile, the first type three-phase coil 9 and the second type three-phase coil 11 may be implemented as winding coils with different thicknesses.

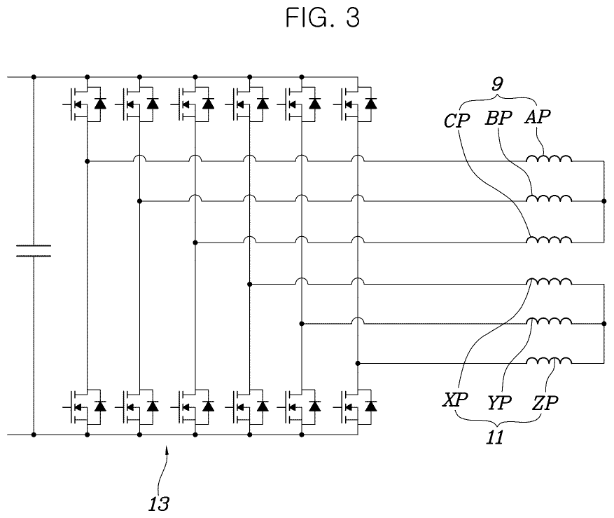

In addition, the six-phase motor including the first type three-phase coils 9 and the second type three-phase coils 11 may comprise a drive circuit illustrated in FIG. 3.

At the right side in FIG. 3, the six-phase coils, which constitute the six-phase motor, are illustrated. The three coils at the upper side include the A-phase coil AP, the B-phase coil BP, and the C-phase coil CP that constitute the first part motor M1. The three coils at the lower side include the X-phase coil XP, the Y-phase coil YP, and the Z-phase coil ZP that constitute the second part motor M2. An inverter 13, which has six legs for operating the six-phase motor, is illustrated at the left side in FIG. 3.

The six-phase motor may be operated by controlling switching elements provided on the legs of the inverter 13.

The present disclosure relates to a technology in which all maximum currents, which may be controlled by the switching elements of the inverter. The technology controls the six-phase motor configured such that the maximum current, which is applied to the first part motor M1 constituted by the first type three-phase coils 9, is equal to the maximum current applied to the second part motor M2. The second part motor M2 is constituted by the second type three-phase coils 11 having a smaller number of series turns per phase than the first type three-phase coils 9.

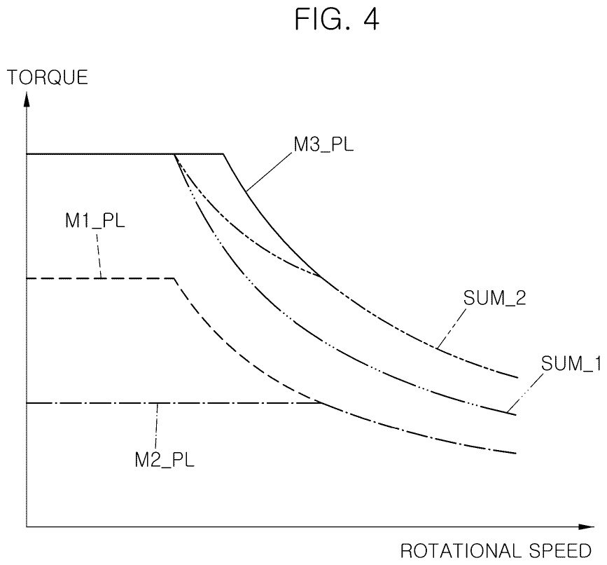

FIG. 4 illustrates a maximum output line M1_PL of the first part motor M1, a maximum output line M2_PL of the second part motor M2, a first maximum combined output line SUM_1, and a second maximum combined output line SUM_2 of the dual winding six-phase motor to which the present disclosure may be applied.

In this case, as described below, the first maximum combined output line SUM_1 is a maximum combined output line when a phase angle of the first part motor M1 and a phase angle of the second part motor M2 are equally controlled. The second maximum combined output line SUM_2 is a maximum combined output line when a phase angle of the first part motor M1 and a phase angle of the second part motor M2 are differently controlled.

For reference, M3_PL is an average of the number of turns of the first type three-phase coil 9 and the number of turns of the second type three-phase coil 11 and refers to a maximum output line of a general six-phase motor in the related art in which all six-phase coils are wound.

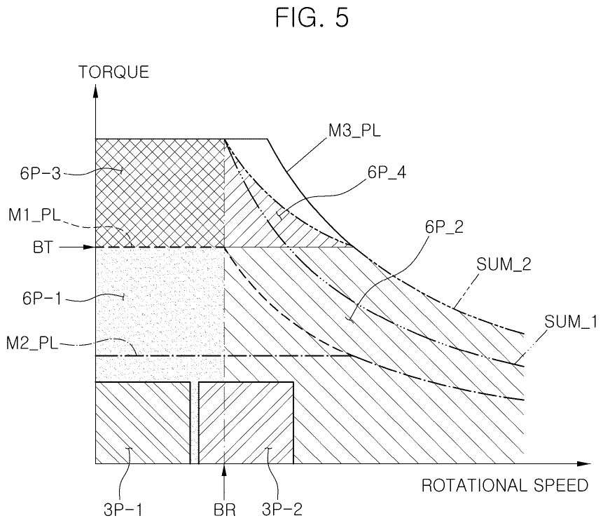

FIG. 5 is a graph illustrating operation regions of the six-phase motor according to the present disclosure on the graph in FIG. 4.

With reference to FIGS. 4 and 5, the motor control method of the present disclosure equally controls output torque of the first part motor M1, which is constituted by the first type three-phase coils 9, and output torque of the second part motor M2, which is constituted by the second type three-phase coils 11, in a region in which required torque of the six-phase motor is equal to or lower than predetermined reference torque BT. The motor control method differently controls the output torque of the first part motor M1 and the output torque of the second part motor M2 in a region in which the required torque of the six-phase motor is higher than the reference torque BT.

In this case, the reference torque BT may be set to twice maximum torque of the second part motor M2.

In other words, in the present disclosure, the output torque of the first part motor M1 and the output torque of the second part motor M2 are equally controlled in an operation region in which the required torque is equal to or lower than twice the maximum torque of the second part motor M2. The second part motor M2 is constituted by the second type three-phase coils 11 having a smaller number of series turns per phase than the first type three-phase coils 9. The output torque of the first part motor M1 and the output torque of the second part motor M2 are differently controlled in an operation region in which the required torque is higher than twice the maximum torque of the second part motor M2.

This is because Noise Vibration Harshness (NVH) performance is high when the torque of the first part motor M1 and the torque of the second part motor M2 are equally controlled in comparison with the situation in which the torque of the first part motor M1 and the torque of the second part motor M2 are differently controlled. Therefore, if possible, the region in which the torque of the first part motor M1 and the torque of the second part motor M2 are equally controlled is expanded to a region defined by the reference torque BT.

In this case, the configuration in which the output torque of the first part motor M1 and the output torque of the second part motor M2 are equally controlled means that the output torque of the first part motor M1 and the output torque of the second part motor M2 have a 1:1 relationship.

In addition, in the region in which the required torque of the six-phase motor is higher than the reference torque BT, the output torque of the first part motor M1 and the output torque of the second part motor M2 are differently controlled in accordance with a ratio between a torque constant of the first part motor M1 and a torque constant of the second part motor M2.

For example, in case that the torque constant of the first part motor M1 is 2 and the torque constant of the first part motor M1 is 1, the first part motor M1 and the second part motor M2 are controlled so that the ratio of the motor torque is 2:1.

For reference, the torque constant is proportional to the number of series turns per phase of the motor.

Meanwhile, in FIG. 5, the six-phase operation region, in which the required torque is equal to or lower than the reference torque BT, includes a first six-phase operation region 6P-1 and a second six-phase operation region 6P-2. In these regions, the torque of the first part motor M1 and the torque of the second part motor M2 are equally controlled as described above. Thus, the NVH performance may be improved.

In addition, in FIG. 5, the six-phase operation region, in which the required torque is higher than the reference torque BT, includes a third six-phase operation region 6P-3 and a fourth six-phase operation region 6P-4. In these regions, the torque of the first part motor M1 and the torque of the second part motor M2 are differently controlled as described above. Thus, the required torque of the six-phase motor may be satisfied.

For reference, in FIG. 5, the portions marked with the same hatching indicate the same operation region.

Meanwhile, the phase angle of the first part motor M1 and the phase angle of the second part motor M2 are equally controlled in a rotational speed region equal to or lower than a predetermined reference rotational speed. The phase angle of the first part motor M1 and the phase angle of the second part motor M2 are differently controlled in a rotational speed region higher than the reference rotational speed.

In this case, a reference rotational speed BR may be set to a base rotational speed of the first part motor M1.

In other words, based on the base rotational speed of the first part motor M1 constituted by the first type three-phase coils 9 having a relatively large number of turns, the phase angle of the first part motor M1 and the phase angle of the second part motor M2 are equally controlled in the rotational speed region equal to or lower than the base rotational speed, and the phase angle of the first part motor M1 and the phase angle of the second part motor M2 are differently controlled in the rotational speed region higher than the base rotational speed. Thus, the maximum output of the six-phase motor may be improved in the rotational speed region higher than the base rotational speed.

With reference to FIG. 4, the maximum combined output line SUM_1 and the maximum combined output line SUM_2 are compared. The maximum combined output line SUM_1 is made when the phase angle of the first part motor M1 and the phase angle of the second part motor M2 are equally controlled. The maximum combined output line SUM_2 is made when the phase angle of the first part motor M1 and the phase angle of the second part motor M2 are differently controlled. In comparison with the maximum combined output line SUM_1 made when the phase angles are equally controlled, the maximum combined output line SUM_2, which is made when the phase angles are differently controlled, may generate a relatively higher maximum output in the rotational speed region higher than the reference rotational speed BR.

Therefore, according to the present disclosure, in the dual winding six-phase motor including the first part motor M1 and the second part motor M2, the phase angle of the first part motor M1 and the phase angle of the second part motor M2 are differently controlled in the rotational speed region higher than the reference rotational speed BR. Thus, the high output performance may be more easily provided in the high-speed operation region required for the vehicle.

In this case, the configuration in which the phase angle of the first part motor M1 and the phase angle of the second part motor M2 are equally or differently controlled may be understood as a configuration in which a phase of the current flowing through the A-phase coil of the first part motor M1 and a phase of the current flowing through the X-phase coil of the second part motor M2 are equal to or different from each other.

Of course, the currents with a phase difference of 120° are supplied to the A-phase coil AP, the B-phase coil BP, and the C-phase coil CP that constitute the first part motor M1. The currents with a phase difference of 120° are supplied to the X-phase coil XP, the Y-phase coil YP, and the Z-phase coil ZP that constitute the second part motor M2.

In FIG. 5, based on the reference rotational speed BR, the first six-phase operation region 6P-1 and the third six-phase operation region 6P-3, in which the phase angle of the first part motor M1 and the phase angle of the second part motor M2 are equally controlled, are illustrated at the left side. The second six-phase operation region 6P-2 and the fourth six-phase operation region 6P-4, in which the phase angle of the first part motor M1 and the phase angle of the second part motor M2 are differently controlled, are illustrated at the right side.

Meanwhile, as illustrated in FIG. 5, a second three-phase operation region 3P-2, in which only the second part motor M2 is operated, is set to a rotational speed region higher than a first three-phase operation region 3P-1 in which only the first part motor M1 is operated.

This eventually means that in case that the six-phase motor of the present disclosure is used as a three-phase motor, the three-phase motor is implemented by operating only the first part motor M1 in the relatively low rotational speed region, and the three-phase motor is implemented by operating only the second part motor M2 in the relatively high rotational speed region.

When the three-phase motor is implemented by operating only the first part motor M1 in the first three-phase operation region 3P-1 that is the relatively low rotational speed region as described above, the number of turns of the first type three-phase coils 9 constituting the first part motor M1 is relatively larger than the number of turns of the second type three-phase coils 11 constituting the second part motor M2. Thus, the required current may be reduced, and a copper loss may be reduced when the operating point remains the same.

In addition, when the three-phase motor is implemented by operating only the second part motor M2 in the second three-phase operation region 3P-2 that is the relatively high rotational speed region as described above, a counter electromotive force may be reduced, and a loss of weak field control may be reduced when the operating point remains the same.

The present disclosure may also be expressed as follows.

In other words, the motor control method of the present disclosure controls the six-phase motor. The six-phase motor is configured such that the maximum current applied to the first part motor M1, which is constituted by the first type three-phase coils 9, is equal to the maximum current applied to the second part motor M2, which is constituted by the second type three-phase coils 11 having a smaller number of series turns per phase than the first type three-phase coils 9. In the six-phase motor, the phase angle of the first part motor M1 and the phase angle of the second part motor M2 are equally controlled in the rotational speed region equal to or lower than the predetermined reference rotational speed BR. In the six-phase motor, the phase angle of the first part motor M1 and the phase angle of the second part motor M2 are differently controlled in the rotational speed region higher than the reference rotational speed BR.

In this case, the reference rotational speed BR is set to the base rotational speed of the first part motor M1.

The operation region, in which only the second part motor M2 is operated, is set to a rotational speed region higher than the operation region in which only the first part motor M1 is operated.

In addition, the output torque of the first part motor M1 and the output torque of the second part motor M2 are equally controlled in the region in which the required torque of the six-phase motor is equal to or lower than twice the maximum torque of the second part motor M2. The output torque of the first part motor M1 and the output torque of the second part motor M2 are differently controlled in accordance with the ratio between the torque constant of the first part motor M1 and the torque constant of the second part motor M2 in the region in which the torque is higher than twice the maximum torque of the second part motor M2.

In addition, the present disclosure, which has been described above, may be expressed as follows.

In other words, the motor control method of the present disclosure controls the six-phase motor. The six-phase motor is configured such that the maximum current applied to the first part motor M1, which is constituted by the first type three-phase coils 9 is equal to the maximum current applied to the second part motor M2, which is constituted by the second type three-phase coils 11 having a smaller number of series turns per phase than the first type three-phase coils 9, in which the six-phase operation region, in which the six-phase motor is operated in six phases, is divided into four operation regions in accordance with a predetermined reference rotational speed and reference torque. In the motor control method, the phase angle of the first part motor M1 and the phase angle of the second part motor M2 are equally controlled. The torque of the first part motor M1 and the torque of the second part motor M2 are equally controlled in the first six-phase operation region 6P-1 in which a rotational speed is equal to or lower than the reference rotational speed, and torque is equal to or lower than the reference torque among the four operation regions. In the motor control method, the phase angle of the first part motor M1 and the phase angle of the second part motor M2 are differently controlled. The torque of the first part motor M1 and the torque of the second part motor M2 are equally controlled in the second six-phase operation region 6P-2 in which a rotational speed is higher than the reference rotational speed, and torque is equal to or lower than the reference torque among the four operation regions. In the motor control method, the phase angle of the first part motor M1 and the phase angle of the second part motor M2 are equally controlled and the torque of the first part motor M1 and the torque of the second part motor M2 are differently controlled in the third six-phase operation region 6P-3 in which a rotational speed is equal to or lower than the reference rotational speed, and torque is higher than the reference torque among the four operation regions. In the motor control method, the phase angle of the first part motor M1 and the phase angle of the second part motor M2 are differently controlled and the torque of the first part motor M1 and the torque of the second part motor M2 are differently controlled in the fourth six-phase operation region 6P-4 in which a rotational speed is higher than the reference rotational speed, and torque is higher than the reference torque among the four operation regions.

The reference rotational speed BR based on which the four operation regions are separated is set to the base rotational speed of the first part motor, and the reference torque BT is set to twice the maximum torque of the second part motor.

The second three-phase operation region 3P-2 in which only the second part motor M2 is operated is set to the rotational speed region higher than the first three-phase operation region 3P-1 in which only the first part motor M1 is operated.

The first three-phase operation region 3P-1 and the second three-phase operation region 3P-2 are set to overlap in the first six-phase operation region 6P-1 and the second six-phase operation region 6P-2.

In case that the torque of the first part motor M1 and the torque of the second part motor M2 are differently controlled, the output torque of the first part motor M1 and the output torque of the second part motor M2 are differently controlled in accordance with the ratio between the torque constant of the first part motor M1 and the torque constant of the second part motor M2.

While the specific embodiments of the present disclosure have been illustrated and described, it should be apparent to those having ordinary skill in the art that the present disclosure may be variously modified and changed without departing from the technical spirit of the present disclosure defined in the appended claims.

What is claimed is:

1. A motor control method for controlling a six-phase motor, the method comprising:
controlling a maximum current applied to a first part motor to be equal to a maximum current applied to a second part motor, wherein the first part motor includes first type three-phase coils, and the second part motor includes second type three-phase coils having a smaller number of series turns per phase than the first type three-phase coils;
equally controlling output torque of the first part motor including the first type three-phase coils and output torque of the second part motor including the second type three-phase coils in a region, in which required torque of the six-phase motor is equal to or lower than predetermined reference torque; and
differently controlling the output torque of the first part motor and the output torque of the second part motor in a region, in which the required torque of the six-phase motor is higher than the reference torque.

2. The motor control method of claim 1, further comprising:
in the region, in which the required torque of the six-phase motor is higher than the reference torque, differently controlling the output torque of the first part motor and the output torque of the second part motor in accordance with a ratio between a torque constant of the first part motor and a torque constant of the second part motor.

3. The motor control method of claim 2, further comprising:
setting the reference torque to twice maximum torque of the second part motor.

4. The motor control method of claim 1, further comprising:
equally controlling a phase angle of the first part motor and a phase angle of the second part motor in a rotational speed region equal to or lower than a predetermined reference rotational speed; and
differently controlling the phase angle of the first part motor and the phase angle of the second part motor in a rotational speed region higher than the reference rotational speed.

5. The motor control method of claim 4, further comprising:
setting the reference rotational speed to a base rotational speed of the first part motor.

6. The motor control method of claim 1, further comprising:
setting an operation region, in which only the second part motor is operated, to a rotational speed region higher than an operation region, in which only the first part motor is operated.

7. A device comprising:
a non-transitory computer-readable storage medium storing instructions executable to perform a motor control for a six-phase motor; and
a processor configured to execute the instructions to:
control a maximum current applied to a first part motor of the six-phase motor to be equal to a maximum current applied to a second part motor of the six-phase motor, wherein the first part motor includes first type three-phase coils, and the second part motor includes second type three-phase coils having a smaller number of series turns per phase than the first type three-phase coils;
equally control an output torque of the first part motor including the first type three-phase coils and an output torque of the second part motor including the second type three-phase coils in a region in which a required torque of the six-phase motor is equal to or lower than a predetermined reference torque; and
differently control the output torque of the first part motor and the output torque of the second part motor in a region in which the required torque of the six-phase motor is higher than the predetermined reference torque.

8. The device of claim 7, wherein the processor is configured to execute the instructions to:
in the region, in which the required torque of the six-phase motor is higher than the predetermined reference torque, differently control the output torque of the first part motor and the output torque of the second part motor based on a ratio between a torque constant of the first part motor and a torque constant of the second part motor.

9. The device of claim 8, wherein the processor is configured to execute the instructions to set the predetermined reference torque to twice maximum torque of the second part motor.

10. The device of claim 7, wherein the processor is configured to execute the instructions to:
equally control a phase angle of the first part motor and a phase angle of the second part motor in a rotational speed region equal to or lower than a predetermined reference rotational speed; and
differently control the phase angle of the first part motor and the phase angle of the second part motor in a rotational speed region higher than the predetermined reference rotational speed.

11. The device of claim 10, wherein the processor is configured to execute the instructions to:
set the predetermined reference rotational speed to a base rotational speed of the first part motor; and
set an operation region, in which only the second part motor is operated, to a rotational speed region higher than an operation region in which only the first part motor is operated.

12. A motor control method for controlling a six-phase motor, the method comprising:
controlling a maximum current applied to a first part motor to be equal to a maximum current applied to a second part motor, wherein the first part motor includes first type three-phase coils, and the second part motor includes second type three-phase coils having a smaller number of series turns per phase than the first type three-phase coils;
equally controlling a phase angle of the first part motor and a phase angle of the second part motor in a rotational speed region equal to or lower than a predetermined reference rotational speed; and
differently controlling the phase angle of the first part motor and the phase angle of the second part motor in a rotational speed region higher than the reference rotational speed.

13. The motor control method of claim 12, further comprising:
setting the reference rotational speed to a base rotational speed of the first part motor.

14. The motor control method of claim 13, further comprising:
setting an operation region, in which only the second part motor is operated, to a rotational speed region higher than an operation region, in which only the first part motor is operated.

15. The motor control method of claim 14, further comprising:
equally controlling output torque of the first part motor and output torque of the second part motor in a region, in which required torque of the six-phase motor is equal to or lower than twice maximum torque of the second part motor; and
differently controlling the output torque of the first part motor and the output torque of the second part motor in accordance with a ratio between a torque constant of the first part motor and a torque constant of the second part motor in a region higher than twice the maximum torque of the second part motor.

16. A motor control method for controlling a six-phase motor, the method comprising:
controlling a maximum current applied to a first part motor to be equal to a maximum current applied to a second part motor, wherein the first part motor includes first type three-phase coils, and the second part motor includes second type three-phase coils having a smaller number of series turns per phase than the first type three-phase coils;
dividing a six-phase operation region, in which the six-phase motor operates in six phases, into four operation regions in accordance with a predetermined reference rotational speed and reference torque;
equally controlling a phase angle of the first part motor and a phase angle of the second part motor and equally controlling torque of the first part motor and torque of the second part motor in a first six-phase operation region, in which a rotational speed is equal to or lower than the reference rotational speed, and torque region is equal to or lower than the reference torque among the four operation regions;
differently controlling the phase angle of the first part motor and the phase angle of the second part motor and equally controlling the torque of the first part motor and the torque of the second part motor in a second six-phase operation region, in which a rotational speed is higher than the reference rotational speed, and torque is equal to or lower than the reference torque among the four operation regions;
equally controlling the phase angle of the first part motor and the phase angle of the second part motor and differently controlling the torque of the first part motor and the torque of the second part motor in a third six-phase operation region, in which a rotational speed is equal to or lower than the reference rotational speed, and torque is higher than the reference torque among the four operation regions; and
differently controlling the phase angle of the first part motor and the phase angle of the second part motor and differently controlling the torque of the first part motor and the torque of the second part motor in a fourth six-phase operation region, in which a rotational speed is higher than the reference rotational speed, and torque is higher than the reference torque among the four operation regions.

17. The motor control method of claim 16, further comprising:
setting the reference rotational speed, based on which the four operation regions are separated, to a base rotational speed of the first part motor; and
setting the reference torque to twice maximum torque of the second part motor.

18. The motor control method of claim 17, further comprising:
setting a second three-phase operation region, in which only the second part motor is operated, to a rotational speed region higher than a first three-phase operation region, in which only the first part motor is operated.

19. The motor control method of claim 18, further comprising:
setting the first three-phase operation region and the second three-phase operation region to overlap in the first six-phase operation region and the second six-phase operation region.

20. The motor control method of claim 17, further comprising:
differently controlling output torque of the first part motor and output torque of the second part motor in accordance with a ratio between a torque constant of the first part motor and a torque constant of the second part motor when the torque of the first part motor and the torque of the second part motor are differently controlled.
